(19) United States
(12) Patent Application Publication
(10) Pub. No.: US 2015/0362206 A1
(43) Pub. Date: Dec. 17, 2015

(54) SYSTEM AND METHOD TO MANAGE ENERGY CONSUMPTION IN AN HVAC SYSTEM

(71) Applicant: Carrier Corporation, Farmington, CT (US)

(72) Inventors: Bryan M. Yarde, Ft. Wayne, IN (US); Michael A. Roher, Ft. Wayne, IN (US); Adam Hendricks, Columbia City, IN (US)

(21) Appl. No.: 14/741,151

(22) Filed: Jun. 16, 2015

Related U.S. Application Data
(60) Provisional application No. 62/095,407, filed on Dec. 22, 2014.
(60) Provisional application No. 62/012,752, filed on Jun. 16, 2014.

(51) Int. Cl. F24F 11/00; H04W 4/00; G05D 23/19

(52) U.S. Cl. CPC F24F 11/006; F24F 11/0012; F24F 11/0086; G05D 23/1917; H04W 4/008; F24F 2011/0047; F24F 2011/0061; F24F 2011/0067; F24F 2011/0068; F24F 2011/0075

(57) ABSTRACT

A system and method to manage energy consumption in an HVAC system including a main system controller, including a near field communication interface, and at least one HVAC component in operable communication with the main system controller; wherein the main system controller is configured to compile energy consumption data from the at least one HVAC component, and transfer said energy consumption data to an auxiliary device via the near field communication interface.

### CROSS REFERENCE TO RELATED APPLICATIONS

The present application is related to, and claims the priority benefit of, U.S. Provisional Patent Application Ser. No. 62/012,752 filed Jun. 16, 2014, and 62/095,407 filed Dec. 22, 2014, the contents of which are hereby incorporated in their entirety into the present disclosure.

### TECHNICAL FIELD OF THE DISCLOSED EMBODIMENTS

The presently disclosed embodiments generally relate to heating, ventilation, and air-conditioning (HVAC) systems, and more particularly, to a system and method to manage energy consumption in an HVAC system.

### BACKGROUND OF THE DISCLOSED EMBODIMENTS

The storage and usage of energy consumption data for HVAC systems is limited due to means available access to analyze the data. Generally, methods used for analyzing energy consumption data require physical media or access to a wireless network with limited storage capability. There is, therefore, a need for a system and method to allow for easier access to energy consumption data for an HVAC system.

### SUMMARY OF THE DISCLOSED EMBODIMENTS

In one aspect, an HVAC system is provided. The HVAC system includes a main system controller including a near field communication interface. The HVAC system further includes at least one HVAC component in operable communication with the main system controller, wherein the main system controller is configured to compile energy consumption data from the at least one HVAC component, and transfer said energy consumption data to an auxiliary device via the near field communication interface. In one embodiment, the at least one HVAC component is selected from a group consisting of a furnace, a fan coil, an air conditioner, and a heat pump. In one embodiment, the main system controller includes a processor, and a memory. The main system controller further includes software stored within the memory for the execution thereof by the processor respectively. In one embodiment, the main system controller includes a display screen.

In one aspect, a method of managing energy consumption within the HVAC system is provided. The method includes the step of operating the at least one HVAC component to condition an interior space based at least in part on a user-defined criteria. In one embodiment, the user-defined criteria include a temperature set point. In another embodiment, the user-defined criteria include a monetary budget.

The method further includes step of operating the main system controller to compile energy consumption data for the at least one HVAC component. In one embodiment, the energy consumption data is selected from a group consisting of electrical consumption data and gas consumption data.

In one embodiment, the method includes step of operating the main system controller to transfer the energy consumption data to an auxiliary device, wherein the auxiliary device includes a device near field communication interface.

In one embodiment, the method further includes the step of operating the main system controller to alter the operation of the at least one HVAC component based at least in part on the user-defined criteria and/or the energy consumption data.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 is a schematic component diagram of an HVAC system according to the present disclosure; and

FIG. 2 is a schematic flow diagram of a method for managing energy consumption within an HVAC system.

### DETAILED DESCRIPTION OF THE DISCLOSED EMBODIMENTS

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

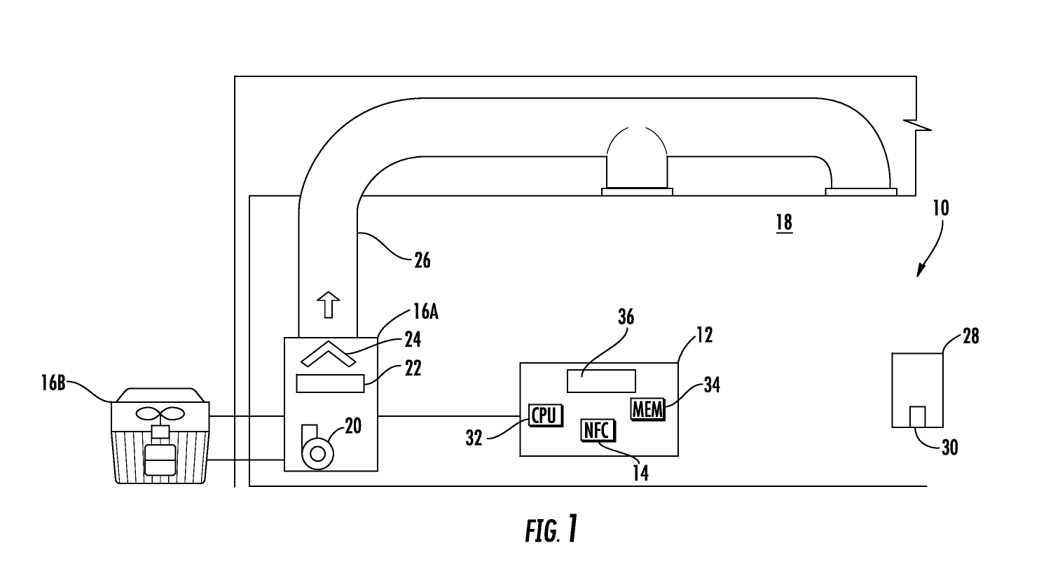

FIG. 1 illustrates an HVAC system in one embodiment, generally referenced at 10. The HVAC system 10 is configured to condition air within the interior space 18. The HVAC system 10 includes a main system controller 12 including a near field communication interface 14. The main system controller 12 is operably coupled to a power supply source (not shown). It will be appreciated that the main system controller 12 may include a computer, thermostat, indoor unit control board, outdoor unit control board, etc. to name a few non-limiting examples. The HVAC system 10 further includes at least one HVAC component 16 in operable communication with the main system controller 12, wherein the main system controller 12 is configured to compile energy consumption data from the at least one HVAC component, and transfer said energy consumption data to an auxiliary device 28 via the near field communication interface 14. It will be appreciated that the auxiliary device 28 may include a mobile device including an auxiliary device near field communication interface 30, such as a phone, tablet, or laptop, to name a few non-limiting examples. The near field communication interfaces 14 and 30 allow a form of contactless communication between the main system controller 12 and the auxiliary device 20. In one embodiment, the at least one HVAC component 16 is selected from a group consisting of a furnace, a fan coil, an air conditioner, and a heat pump. It will be appreciated that the at least one HVAC component 16 may also include other devices within an HVAC system 10, such as, a humidifier, ventilator, dampers, dehumidifier, etc. to name a few non-limiting examples.

In one embodiment, the main system controller 12 includes a processor 32, and a memory 34, for example read only memory (ROM) and electrically erasable programmable read only memory (EEPROM) to name two non-limiting examples. The main system controller 12 further includes software stored within the memory 34 for the execution thereof by the processor 32 respectively. In one embodiment, the main system controller 12 includes a display screen 36, for example a liquid crystal display (LCD) to name one non-limiting example.

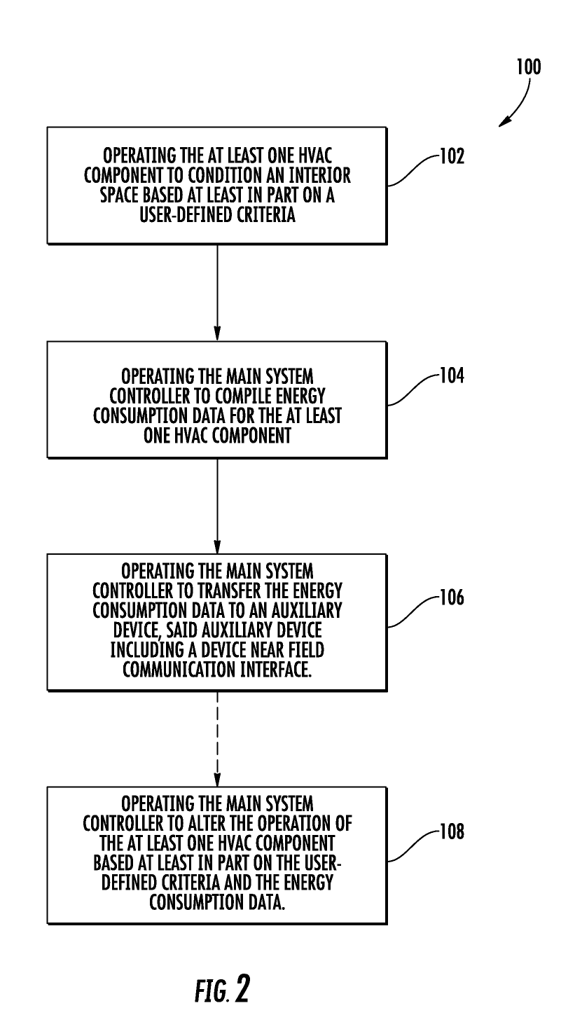

FIG. 2 illustrates a schematic flow diagram of an exemplary method 100 of managing energy consumption within the HVAC system 10. The method 100 includes the step 102 of operating the at least one HVAC component 16 to condition an interior space 18 based at least in part on a user-defined criteria. In one embodiment, the user-defined criteria include a temperature set point. In another embodiment, the user-defined criteria include a monetary budget. It will be appreciated that the user-defined criteria may include other criteria, such as, a humidity set point to name one non-limiting example. For example, a user may set a daily schedule on the main system controller 12 to operate at specific temperatures throughout the day in an effort to conserve energy. Moreover, the user may enter a monetary budget within the main system controller 12 or the auxiliary device 28 in order to maintain operation of the at least one HVAC component 16 accordingly.

For example, during operation, air enters a return duct (not shown) to provide source air, i.e., air to be conditioned, to the rest of the HVAC system 10. When the blower 20 operates, it pulls air from the interior space 18 and/or the outside environment into the return duct into the HVAC component 16A. The blower 20 pushes the air past a heating unit 22 and/or a cooling unit 24 and into a supply duct 26. The heating unit 22 and the cooling unit 24 are activated to heat and cool the air, respectively, depending on the needs of the interior space 18, as determined by the user-defined criteria set within the main system controller 12. The main system controller 12 is generally placed in the interior space 16 to monitor the temperature conditions and provide information to, and receive settings from, a user.

When the main system controller 12 determines that the interior space 18 is too cold, i.e., that the current temperature is below a user-defined limit, the main system controller 12 will send a heating call to the furnace 16A. In response, the furnace 16A activates the heating unit 22 and the blower 20. It will be appreciated that the heating unit 22 may include electric heating or gas heating. The blower 20 will pull air into the return duct (not shown) and will push the air past the active heating unit 22 and the inactive cooling unit 24 before the heated air is supplied to the interior space 18 through the supply duct 26.

If the main system controller 12 had determined that the temperature within the interior space had instead risen above a user-defined limit, the main system controller 12 would have sent a cooling call signal to the furnace 16A and the air conditioner 16B. In response, the air conditioner 16B operates to provide refrigerant to the cooling unit 24. The blower 20 will pull air into the return duct (not shown) and will push the air past the inactive heating unit 22 and the active cooling unit 24 before the cooled air is supplied to the interior space 18 through the supply duct 26.

The method 100 further includes step 104 of operating the main system controller 12 to compile energy consumption data for the at least one HVAC component 16. In one embodiment, the energy consumption data is selected from a group consisting of electrical consumption data and gas consumption data. It will be appreciated that the energy consumption data may include water consumption. For example, while the at least one HVAC component 16 is responding to a heating call signal, the main system controller 12 receives, or extrapolates, information on the run time for the blower 20 to compile electrical consumption data. The main system controller 12 also receives, or extrapolates, information on the amount of gas used by the heating unit 22 to compile gas consumption data. Additionally. while the at least one HVAC component 16 is responding to a cooling call signal, the main system controller 12 receives, or extrapolates, information on the run time for the blower 20 and the at least one system component 16B, to compile electrical consumption data.

In one embodiment, the method 100 includes step 106 of operating the main system controller 12 to transfer the energy consumption data to an auxiliary device 28, wherein the auxiliary device 28 includes a device near field communication interface 30. For example, as auxiliary device 28 is placed in close proximity to the main controller 12, the processor 16 executes software stored in memory 18 to transfer the energy consumption data to the auxiliary device. It will be appreciated that the auxiliary device 30 may operate a software program to present the energy consumption data in any suitable way (e.g. charts, graphs, tables, and text to name a few non-limiting examples) defined by a user.

In one embodiment, the method 100 further includes the step 108 of operating the main system controller 12 to alter the operation of the at least one HVAC component 16 based at least in part on the user-defined criteria and/or the energy consumption data. For example, if after review of the energy consumption data, the user may change the temperature set point to a lower temperature before operating the heating unit 22 and/or to a higher temperature before operating the cooling unit 24. Additionally, the energy consumption data may be converted into monies spent by multiplying the energy consumption data by its respective utility rate. The user may then compare the energy consumption data with a monetary budget and alter the operation of the HVAC component 16 accordingly. Furthermore, the main system controller 12 may automatically change the temperature set point to a system default setting based on the energy consumption data.

It will therefore be appreciated that the main system controller 12 may transfer energy consumption data to an auxiliary device 28 to allow a user to monitor the energy used by the at least one HVAC component 16, and alter the operation of the at least one HVAC component 16 based on the energy consumption data.

While the invention has been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method of managing energy consumption within an HVAC system including a main system controller, including a near field communication interface, in operable communication with at least one HVAC component, the method comprising the steps of:
(a) operating the at least one HVAC component to condition an interior space based at least in part on a user-defined criteria;
(b) operating the main system controller to compile energy consumption data for the at least one HVAC component; and
(c) operating the main system controller to transfer the energy consumption data to an auxiliary device, said auxiliary device including a device near field communication interface.

2. The method of claim 1, further comprising the step of:
(d) operating the main system controller to alter the operation of the at least one HVAC component based at least in part on the user-defined criteria and/or the energy consumption data.

3. The method of claim 1, wherein the energy consumption data is selected from a group consisting of electrical consumption data and gas consumption data.

4. The method of claim 1, wherein the at least one HVAC component is selected from a group consisting of a furnace, a fan coil, an air conditioner, and a heat pump.

5. The method of claim 1, wherein the user-defined criteria comprises a temperature set point.

6. The method of claim 1, wherein the user-defined criteria comprises a monetary budget.

7. An HVAC system comprising:
a main system controller, including a near field communication interface; and
at least one HVAC component in operable communication with the main system controller;
wherein the main system controller is configured to compile energy consumption data from the at least one HVAC component, and transfer said energy consumption data to an auxiliary device via the near field communication interface.

8. The HVAC system of claim 7, wherein the at least one HVAC component is selected from a group consisting of a furnace, a fan coil, an air conditioner, and a heat pump.

9. The HVAC system of claim 7, wherein the energy consumption data is selected from a group consisting of electrical consumption data and gas consumption data.

10. An HVAC controller comprising:
a processor;
a memory;
a first near field communication interface; and
executable software stored in the memory;
wherein the executable software initiates a pairing event when an auxiliary device including a second near field communication interface is placed in close proximity to the first near field communication interface;
wherein the pairing event includes a transfer of energy data from the first near field communication interface to the second near field communication interface.

11. The HVAC controller of claim 10, wherein the HVAC controller further comprises a display screen.

12. The HVAC controller of claim 10, wherein the energy data comprises energy consumption data compiled from at least one HVAC component.

13. The HVAC controller of claim 10, wherein the energy consumption data is selected from a group consisting of electrical consumption data and gas consumption data.
